(19) United States
(12) Patent Application Publication
(10) Pub. No.: US 2017/0003546 A1
(43) Pub. Date: Jan. 5, 2017

(54) Bidirectional LED Backlight For In-Vehicle LCD Displays

(71) Applicant: Dimension Technologies Inc., Rochester, NY (US)

(72) Inventor: Jesse B. Eichenlaub, Penfield, NY (US)

(21) Appl. No.: 15/196,508

(22) Filed: Jun. 29, 2016

Related U.S. Application Data
(60) Provisional application No. 62/186,642, filed on Jun. 30, 2015.

(51) Int. Cl. G02F 1/1335; F21V 8/00

(52) U.S. Cl. CPC G02F 1/133606; G02F 1/133603; G02B 6/001; G02B 6/0006

(57) ABSTRACT

A backlight for liquid crystal displays which directs light to the general areas where observers' heads and eyes are located. In particular, the backlight is designed to direct light toward the driver and passenger positions in an automobile or other vehicle in such a way that the amount of light directed to either person can be varied independently.

### REFERENCE TO RELATED APPLICATIONS

This application claims one or more inventions which were disclosed in Provisional Application No. 62/186,642, filed Jun. 30, 2015, entitled “Bidirectional LED Backlight For In-Vehicle LCD Displays”. The benefit under 35 USC §119(e) of the United States provisional application is hereby claimed, and the aforementioned application is hereby incorporated herein by reference.

### BACKGROUND OF THE INVENTION

### Field of the Invention

The current invention is related to a backlight device designed for use in a liquid crystal (LCD) display.

### SUMMARY OF THE INVENTION

The current invention is related to a backlight device designed for use in a liquid crystal (LCD) display. In particular it is related to a backlight that achieves higher efficiency than conventional backlights by directing light only to the general areas where observers' heads and eyes are located. In particular, the backlight is designed to direct light toward the driver and passenger positions in an automobile or other vehicle in such a way that the amount of light directed to either person can be varied independently. Furthermore, the backlight directs light preferentially toward the limited area where each person's head and eyes are typically located while seated in the vehicle, with much less light directed into other areas. This greatly increases the power efficiency of the display since light is not wasted by sending it to areas, such as between the seats, where no-one is present or needs to see the display. A typical use for a display with such a backlight would be as a central console display in an automobile, though other uses and applications are possible.

### BRIEF DESCRIPTION OF THE DRAWING

FIG. 1 shows a perspective view of an LCD display.

FIG. 2 shows a cross-sectional top view of the LCD display.

FIG. 3 shows the driver and passenger head positions within a particular automobile.

FIG. 4 shows a cross sectional top view of an alternate backlight configuration.

### DETAILED DESCRIPTION OF THE INVENTION

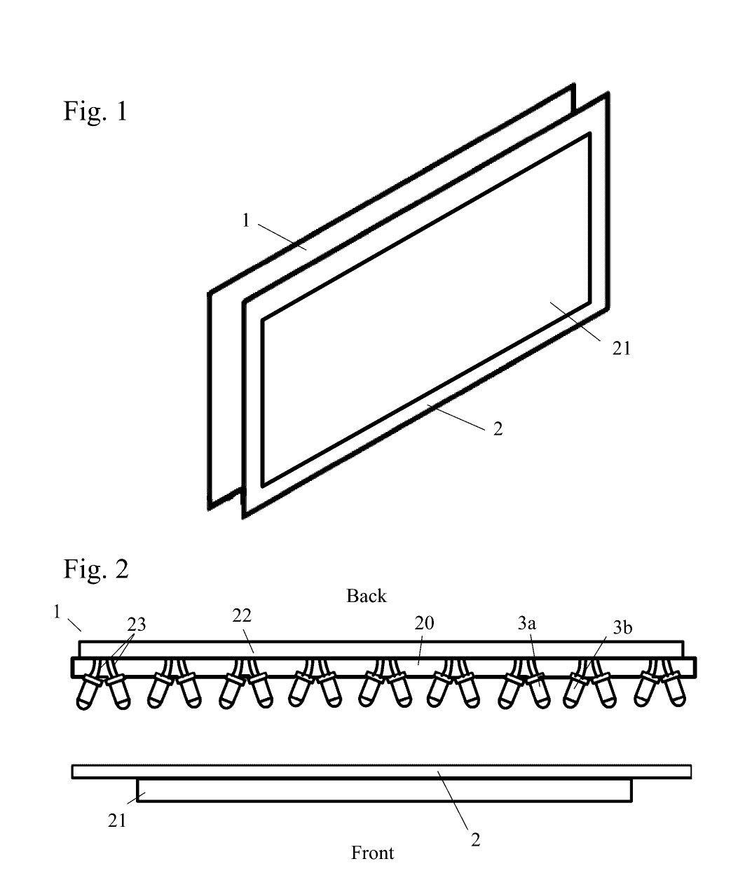

FIG. 1 shows a perspective view of an LCD display, which is made up of an light emitting diode (LED) backplane 1 and a diffuser 2, which together illuminate a liquid crystal display (LCD) panel 21.

FIG. 2 is a cross section top view of the display design, which is designed to provide independently controlled illumination of the LCD panel for two observers located in front of the LCD panel and on opposite sides of a centerline of the panel. For purposes of orientation in the description below, “up” is the direction perpendicular to the page and toward the reader, “down” is perpendicular to the page and away from the reader. The horizontal direction is in the plane of the page to the left and right. “Front” is toward the bottom of the page, and “Back” is toward the top of the page.

In FIG. 2, two sets of LEDs 3a and 3b are shown mounted in a planar substrate 20, which can be made of plastic. The LEDs are angled in two different directions, to the left 3b and to the right 3a. The LEDs 3a 3b can be mounted by placing them in holes fashioned in the planar substrate and held with friction, or by pressure from a rear mounting plate 22 containing electrical connections 23 providing power to all the LEDs 3a and 3b. The planar substrate 20 will typically be larger in the vertical and horizontal directions than the image area on the LCD 21. The LEDs 3a and 3b will typically be spaced across most of its surface area in straight rows and columns. In FIG. 2, each of the LEDs 3a and 3b shown represents and entire column of LEDs that runs from the top of the planar substrate 20 to the bottom.

The LEDs 3a and 3b should be of the type with built in lenses, being in the form of the typical bullet shape shown in the drawing. The LEDs and lenses should be designed to cast their light across some moderate angle, with a 30 degree full width half maximum angle found to be ideal in an experimental backlight that has been built and tested. However, other angles can be used, depending on design details and observer viewing positions.

The LEDs angled to the left 3b are preferably powered independently from the LEDs angled to the right 3a so that each set can be independently turned on and off as well as adjusted for brightness. Controls for both can be provided by means of knobs or switches near the display, or menus and symbols controlled via a touch screen.

A diffuser 2 is placed at a distance in front of the LEDs 3a and 3b. The diffuser 2 must be strong enough to spread the light from the LEDs 3a and 3b sufficiently so that observers sitting at the typical viewing positions in front of the display do not see bright spots created by the LEDs. Furthermore, the LEDs 3a and 3b must be close enough together that their cones of light overlap each other at the diffuser 2, again for the purpose of avoiding hot spots.

The LCD 21 can be placed immediately in front of the diffuser 2 as shown in FIG. 2. In some configurations the diffuser 2 can be attached to the back of the LCD 21.

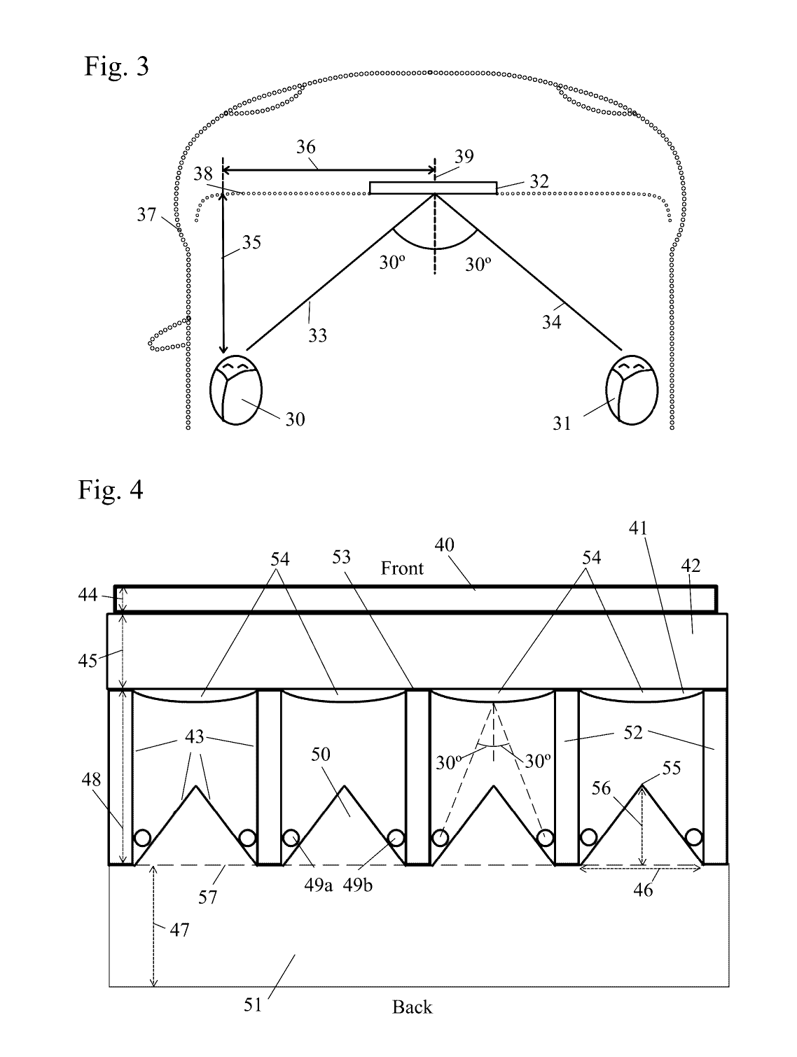

FIG. 3 represents the driver 30 and passenger 31 head positions within a particular automobile 37 which has an LCD backlight display 32 in a central position on the dashboard. The display 32 is designed to direct independently controlled illumination to two observers 30 and 31 located in front of and to either side of the LCD panel 32

In the example automobile 37, the driver's 30 eyes are a distance 35 of approximately 770 mm (30 inches) from the dashboard 28, and the centerline 39 of the LCD panel 32 is approximately 420 mm (16.5 inches) from the driver's 30 position. The distances to the passenger 31 on the other side of the car 37 are similar. With this arrangement, the driver's 30 eyeline 33 makes a viewing angle of approximately 30° to the LCD centerline 39. Similarly, the passenger's 31 eyeline 34 also makes a viewing angle of approximately 30°.

FIG. 4 is a cross sectional top view of an alternate backlight configuration that accomplishes the same task, but is more compact and may be less expensive to build than the configuration described above. The orientation of the drawing in this case is the same as the previous two in terms of the “up” and “down” directions being perpendicular to the page and “horizontal” directions being in the plane of the page, but in this case the “front” is toward the top of the page and the “back” is toward the bottom of the figure. Observers look at the display from the front direction, off to either side of the display.

The rear component of the backlight consists of a piece of plastic or other material 51 with a plurality of sawtooth shaped ridges 50 on the front surface 57 as shown. The rear component 51 should be slightly wider and taller than the image forming area of the LCD 40. The sawtooth shaped ridges 50 extend forward from the front surface 57 of the rear component 51 to an apex 55 at a height 56 forward of the front surface 57 of the rear component 51.

The saw tooth structures 50 can be placed slightly apart from each other as shown, providing flat gaps within which straight standoffs 52 can be molded or inserted as shown.

The saw teeth 50 and standoffs 52 will extend vertically from near the top of the rear component 51 to the bottom. The sides 43 of the saw tooth structures 50 and the standoffs 52 should ideally be smooth and highly reflective, with mirror like aluminized surfaces being best.

Straight fiber optic strands 49a and 49b are placed in the corners at the intersection between the edges of the saw tooth structures 50 and the straight standoffs 52 as shown. The fibers 49a and 49b extend at least from the top to the bottom of the rear component 51. The fiber optic strands 49a and 49b are preferably of the side-emitting type that scatter light evenly out of their sides, instead of directing it efficiently from one end to the other, as most fiber optics do. Such fibers are made by Corning Glass under the brand name Fibrance.

Light is inserted into the fibers 49a located on the left side of each saw tooth structure 50 independently from the fibers 49b located on the right side of each saw tooth structure. The easiest way to accomplish this would be to extend the fibers 49a and 49b well beyond the top and bottom of the rear component 51; enough so that the ends of each of all the fibers 49a on the left side of each saw tooth structure can be collected into a bundle and coupled to a single light source, such as a bright LED, and the ends of all of the fibers 49b on the right side of each saw tooth structure can be collected into a bundle and coupled to a second light source. Each of the LEDs can be independently controlled in terms of brightness and turn on/turn off.

Those parts of the fibers 49a and 49b that extend beyond the top and bottom edges of the rear component should lack the scattering structures that cause them to emit light through their sides. This would allow light to be transported efficiently from the light sources to the side-scattering section of fiber in front of the rear component with little loss.

The standoffs 52 should all be of generally the same dimension 48 in the direction extending away from the rear component 51, so that a lenticular lens array 41 can be butted against, and in most cases attached, to the standoffs 52 in the position shown. The lenticular lens array 41 may consist of a flat piece of plastic with a series of cylindrical lenses 54 molded into one surface. Alternatively, the lenticular lens array 41 could be a flat plastic or glass substrate that is flat on both sides, with lenses 54 molded or cast from a second material attached to one surface. The lenses 54 of the lenticular lens array 41 will be wide enough to fill the space between the standoffs 52 and will also extend from the top to the bottom of the rear component 51, ideally being at least of the same dimension from top to bottom and side to side as the rear component 51. There will preferably be small gaps 53 between the lenses 54, allowing the standoffs 52 to fit between the lenses 54 and be attached to the lenticular lens array 41 via glue or other means.

A diffuser 42 will be placed on the front of the lenticular lens array 41 as shown, on the side opposite the lenses 54. The diffuser 42 must be diffuse light enough to spread the light exiting the lenticular lenses 54 to such an extent that, to a person viewing the backlight from the front, the gaps 53 where the standoffs 52 are attached are invisible. Yet the amount of diffusion must still be weak enough that the light exiting the lenses 54 is still concentrated in the area near the two observer's head positions. The optimum amount of diffusion will depend on the exact design of the backlight, especially the exact thicknesses of the standoffs 52 and the distance between the diffuser 42 and the lenticular lenses 54 and standoffs 52.

Since light is emitted evenly along the length of each fiber 49a and 49b, and given that there are no light blocking elements along the length of the fibers 49a and 49b or the saw teeth 50, standoffs 52, and lenses 54, there is no reason for much diffusion to occur in the vertical direction. Therefore, the best diffuser to use will be of the elliptical or unidirectional type, producing more diffusion in the horizontal direction that the vertical direction.

Example dimensions for the elements in FIG. 4 could be a thickness 44 of 0.25 mm for the LCD panel 40, a thickness 45 of 1.5 mm for the diffuser 42, a length 48 of 2 mm for the standoffs 52, a thickness of 2 mm of the rear component 51, measuring from the rear of the rear component 51 to the base of the saw tooth structures 50. The saw tooth structures 50 could have a cross-sectional form of equilateral triangles as shown, with a base and side dimension 46 of 2 mm.

Note that the drawing in FIG. 4 is not to scale. The dimensions given in the drawing are simply an illustration of typical dimensions. They are not meant to imply that dimensions within the device are limited to those values or even necessarily anything close to them. The 30 degree angle between the fiber optic stands and the centers of the lenticular lenslets are ideal for one particular model of automobile, where the driver's and passenger's heads are typically located in the positions shown in FIG. 3; however angles in this range are believed to be typical for a wider range of automobiles.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A backlight for providing independently controlled illumination of a liquid crystal display to a first observer at a location in front of the liquid crystal display on a first side of a centerline of the liquid crystal display and to a second observer at a location in front of the liquid crystal display on a an opposite side of the centerline of the liquid crystal display, comprising:
a planar substrate;
a first array of light emitting diodes mounted across the planar substrate, having a light output directed at an angle toward the location of the first observer on the first side of the centerline of the liquid crystal display;
a second array of light emitting diodes mounted across the planar substrate, having a light output directed at an angle toward the location of the second observer on the opposite side of the centerline of the liquid crystal display; and
a diffuser in front of the first array of light emitting diodes and second array of light emitting diodes;
wherein a brightness of the first array of light emitting diodes is independently controllable from a brightness of the second array of light emitting diodes.

2. The backlight of claim 1, in which the light emitting diodes of the first array of light emitting diodes and the light emitting diodes of the second array of light emitting diodes have integral lenses.

3. The backlight of claim 2, in which the integral lenses create a beam angle of about 30 degrees.

4. The backlight of claim 1 in which the light emitting diodes of the first array of light emitting diodes and the light emitting diodes of the second array of light emitting diodes are arranged in straight rows and columns.

5. The backlight of claim 1, in which the light emitting diodes of the first array of light emitting diodes and the light emitting diodes of the second array of light emitting diodes are mounted within holes in the planar substrate and held in place with a pressure fit.

6. The backlight of claim 1, further comprising a liquid crystal display mounted in front of the diffuser, the planar substrate being larger in horizontal and vertical dimensions than an image area of the liquid crystal display.

7. The backlight of claim 1, in which the light emitting diodes of the first array of light emitting diodes and the light emitting diodes of the second array of light emitting diodes are mounted sufficiently close enough that light cones of the light emitting diodes overlap on the diffuser.

8. The backlight of claim 1, in which a strength of the diffuser is sufficiently strong that the first observer and second observer do not see bright spots caused by the light emitting diodes.

9. A backlight for providing independently controlled illumination of a liquid crystal display to a first observer at a location in front of the liquid crystal display on a first side of a centerline of the liquid crystal display and to a second observer at a location in front of the liquid crystal display on a an opposite side of the centerline of the liquid crystal display, comprising:
a generally planar substrate having a plurality of sawtooth-shaped ridges extending to an apex at a height from a front surface of the substrate toward the liquid crystal display, each of the sawtooth-shaped ridges being separated from an adjacent sawtooth-shaped ridge by a gap;
a plurality of standoffs, each having a first end mounted in a gap between sawtooth-shaped ridges and second end extending a length toward the liquid crystal display greater than the height of the sawtooth-shaped ridges;
a first set of side-emitting fiber optic strands, each side-emitting fiber optic strand being located in a corner on a first side of the apex of the sawtooth-shaped ridges adjacent one of the plurality of standoffs, such that light emitted from the first set of side-emitting fiber optic strands exits the backlight in a direction toward the location of the first observer;
a second set of side-emitting fiber optic strands, each side-emitting fiber optic strand being located in a corner on a second side of the apex of the sawtooth-shaped ridges adjacent one of the plurality of standoffs, such that light emitted from the second set of side-emitting fiber optic strands exits the backlight in a direction toward the location of the second observer;
at least one light source coupled to the first set of side-emitting fiber optic strands and to the second set of side-emitting fiber optic strands; and
a diffuser mounted to the second end of the plurality of standoffs, in front of the apexes of the plurality of sawtooth-shaped ridges.

10. The backlight of claim 9, further comprising a lens array mounted between the second end of the plurality of standoffs and the diffuser, the lens array comprising a plurality of lenses located between each of the plurality of standoffs.

11. The backlight of claim 10, in which the lens array has gaps between the lenses, the plurality of standoffs fitting within the gaps between the lenses.

12. The backlight of claim 10, wherein an angle between a center of each of the fiber optic strands of the first set of side-emitting fiber optic strands and a center each of the fiber optic strands of the second set of side-emitting fiber optic strands form an angle of 30 degrees with a normal line at a center of the lens in front of the fiber optic strands.

13. The backlight of claim 9, in which the sawtooth-shaped ridges and the standoffs are reflective.

14. The backlight of claim 9, in which the at least one light source comprises a first light source coupled to the first set of side-emitting fiber optic strands and a second light source coupled to the second set of side-emitting fiber optic strands, wherein a brightness of the first light source is independently controllable from a brightness of the second light source.

15. The backlight of claim 9, in which the side-emitting optical fibers emit light only in those sections of fiber that are located between the sawtooth-shaped ridges.

16. The backlight of claim 9, in which the diffuser is an elliptical diffuser that diffuses more in a horizontal direction than a vertical direction.

17. The backlight of claim 9, in which a strength of the diffuser is sufficiently strong that the first observer and second observer do not see gaps caused by the standoffs.
